(19) United States
(12) Patent Application Publication
(10) Pub. No.: US 2018/0202334 A1
(43) Pub. Date: Jul. 19, 2018

(54) Exhaust Muffler For Marine Engine Exhaust System

(71) Applicant: Indmar Products Company Inc., Millington, TN (US)

(72) Inventors: Kevin J. Kimball, Mount Dora, FL (US); Rachel M. Mashburn, Apopka, FL (US)

(21) Appl. No.: 15/406,993

(22) Filed: Jan. 16, 2017

(51) Int. Cl. F01N 1/08; F01N 3/04; F01N 13/00; G10K 11/16

(52) U.S. Cl. CPC F01N 1/083; G10K 11/161; F01N 13/004; F01N 3/043

(57) ABSTRACT

An exhaust muffler for a marine exhaust system includes an inner conduit, an outer conduit surrounding the inner conduit and a plurality of spiral baffles extending radially outward from the inner conduit to the outer conduit. The outer conduit has end portions connectable to exhaust conduits for directing a mixture of fluid and exhaust gas towards an exhaust system outlet. The mixture flows through the inner conduit and through a cooling passage between the conduits. One or more of the spiral baffles has multiple openings for improving the mixing process of exhaust gas and fluid.

### TECHNICAL FIELD

The present invention relates generally to exhaust systems for marine engines, and more particularly, to liquid-cooled marine engine exhaust systems.

### BACKGROUND

Exhaust systems for marine engines generally include an exhaust manifold connected to the engine at each row (or “bank”) of engine cylinders, and a corresponding exhaust conduit coupled to the exhaust manifold for directing exhaust gases from the manifold to an exhaust outlet. In conventional exhaust systems, the exhaust conduit includes a catalytic converter assembly having a catalyst that removes harmful emissions from the exhaust gases before being expelled through the exhaust outlet.

Exhaust systems can experience extremely high temperatures during use. For example, the core temperature of a catalytic converter in a conventional exhaust system can reach upwards of 1,000 degrees Fahrenheit (° F.) or more. For safety purposes, the U.S. Coast Guard requires that exterior surface temperatures of marine engine exhaust systems be maintained below 200° F. Accordingly, components of conventional marine engine exhaust systems, including the catalytic converter assemblies, are often liquid-cooled to ensure safe and compliant operating temperatures.

Referring to FIG. 1, a muffler 5 of a conventional marine engine exhaust system is shown. The muffler 5 includes an upper baffle 6 and a lower baffle 7 inside an outer conduit 8 of the muffler 5. The outer conduit 8 defines a passage 9 through which a mixture M of cooling liquid, such as water, and exhaust is directed from an outlet hose (not shown) of a marine engine exhaust system. One disadvantage of such a muffler is that the mixture M may cool only the bottom portion of the muffler, the upper portion of the muffler 5 becoming too hot, potentially exceeding Coast Guard regulations.

This configuration of muffler 5 may trap precipitated salts and other particulates from cooling mixture M along the bottom of the outer conduit 8 of the muffler 5, particularly when the mixture includes salt water. Buildup of these salts and particulates and residual fluid may disadvantageously result in corrosion and eventual cracking of at least the outer conduit 8 of the muffler 5.

An additional disadvantage of the configuration of muffler 5 shown in FIG. 1 may be inefficient mixing of coolant and gas which may result in undesirable back pressure in the engine, thereby reducing the horsepower of the engine. Other disadvantages of the configuration of muffler 5 shown in FIG. 1 may be undesirable engine noise and insufficient mixing of water and exhaust.

Accordingly, there is a need for an improved muffler for marine engine exhaust systems to address these and other shortcomings.

### SUMMARY

According to an exemplary embodiment of the invention, an exhaust muffler for a marine exhaust system includes an inner conduit and an outer conduit surrounding the inner conduit. Although the inner and outer conduits are shown and described as tubes, each having a uniform diameter and a circular cross-section, either one or both of the conduits may have a non-circular cross-sectional configuration such as a rectangular or oval cross-sectional configuration. In the illustrated embodiments, the inner and outer conduits are concentric about a central axis.

The inner and outer conduits define a cooling passage between the inner and outer conduits. The outer conduit has an outwardly extending annular ring at each end which when used with clamps assist in securing the muffler to exhaust conduits. The outer conduit has an inlet end portion for connection to a first exhaust conduit and an outlet end portion for connection to a second exhaust conduit that directs exhaust gases and liquid toward an exhaust system outlet.

The exhaust muffler further comprises helically-shaped or spiral baffles in the cooling passage. Each of the helically-shaped baffles is secured to at least one of the inner and outer conduits of the muffler, preferably by any number of weld seams of any desired length. At least one of the baffles may have openings therethrough to facilitate mixing or swirling of liquid and exhaust gas inside the cooling passage. The improved mixing inside the muffler reduces the skin temperature of the entire muffler, reduces the sound or noise of the marine muffler and reduces emissions from the exhaust system. The muffler of the present invention reduces backpressure in the marine engine relative to known mufflers in the marine industry thereby improving the marine engine's power and performance. Although the drawings show the muffler being a certain size, the drawings are not intended to limit the size of the muffler including the diameter or length of either the inner conduit or the outer conduit of the muffler.

According to another exemplary embodiment of the invention, an exhaust muffler for a marine exhaust system includes an inner conduit that directs a mixture of fluid and exhaust gases from an exhaust manifold downstream towards an exhaust system outlet. An outer conduit surrounds the inner conduit so as to define a cooling passage between the inner and outer conduits. The inner conduit has a smooth interior through which liquid and gas pass. The inner and outer conduits each have inlet and outlet edges. The outer conduit has annular rings spaced from inlet and outlet edges of the outer conduit to retain conduits over the annular rings and clamps outside the conduits. The exhaust muffler further comprises helically-shaped baffles in the cooling liquid passage. At least one of the baffles may have any number of openings therethrough to facilitate mixing or swirling of liquid and exhaust gas inside the cooling passage.

According to another exemplary embodiment of the invention, an exhaust muffler for a marine exhaust system includes an inner conduit and an outer conduit surrounding the inner conduit so as to define a cooling passage between the inner and outer conduits. The exhaust muffler further comprises spiral baffles in the cooling liquid passage. At least one of the baffles has openings therethrough to facilitate mixing of liquid and exhaust gas inside the cooling passage. Some mixture of liquid and exhaust gas flows through the inner conduit and some of the mixture flows through the cooling passage.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

The drawings, which are incorporated in and constitute a part of this specification, illustrate embodiments of the invention and, together with the general description given above and the detailed description given below, serve to explain the embodiments of the invention.

FIG. 1 is a perspective view of a muffler of a known muffler of a known marine engine exhaust system.

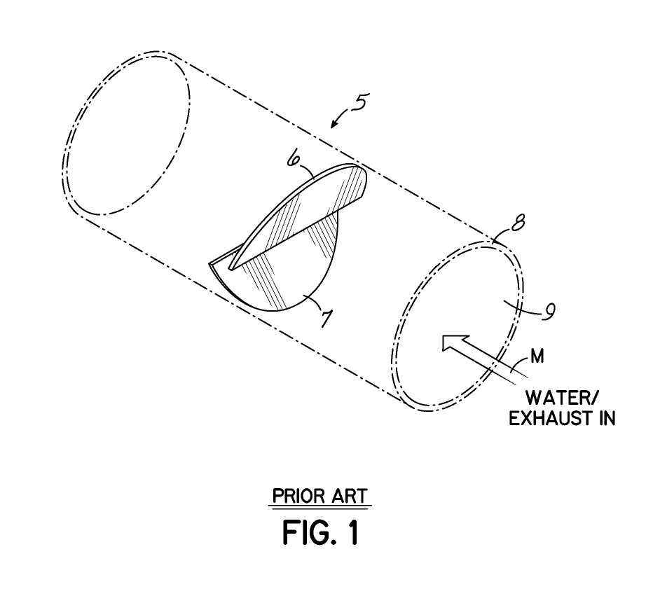

FIG. 2 is a top view of a motorboat including an inboard engine and an exhaust system coupled to the engine.

FIG. 3 is a perspective view of a marine engine exhaust system according to an exemplary embodiment of the invention.

FIG. 4 is a side cross-sectional view taken along line 4-4 in FIG. 3, showing details of an exhaust conduit and an exhaust manifold of the exhaust system.

FIG. 5 is a perspective view of the muffler of the marine engine exhaust system of FIG. 3.

FIG. 5A is a perspective view of another embodiment of muffler of marine engine exhaust system.

FIG. 5B is a perspective view of another embodiment of muffler of marine engine exhaust system.

FIG. 6 is an axial cross-sectional view of the muffler of FIG. 5.

### DETAILED DESCRIPTION

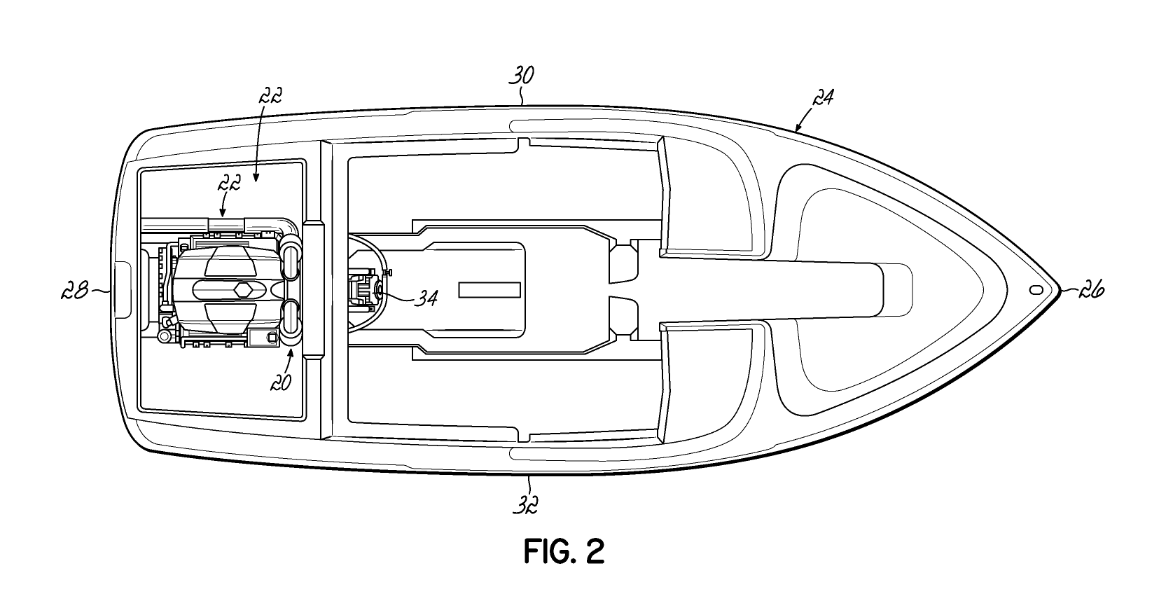

Referring to FIG. 2, an exhaust system 20 according to an exemplary embodiment of the invention is shown mounted to a marine engine 22 within a motorboat 24. The motorboat 24 includes a bow 26, a stern 28, a port side 30, and a starboard side 32. The engine 22 is shown mounted in an “inboard” configuration and is coupled to a V-drive transmission 34 that drives a propeller shaft and propeller (not shown) to rotate, which propels the motorboat 24 through the water.

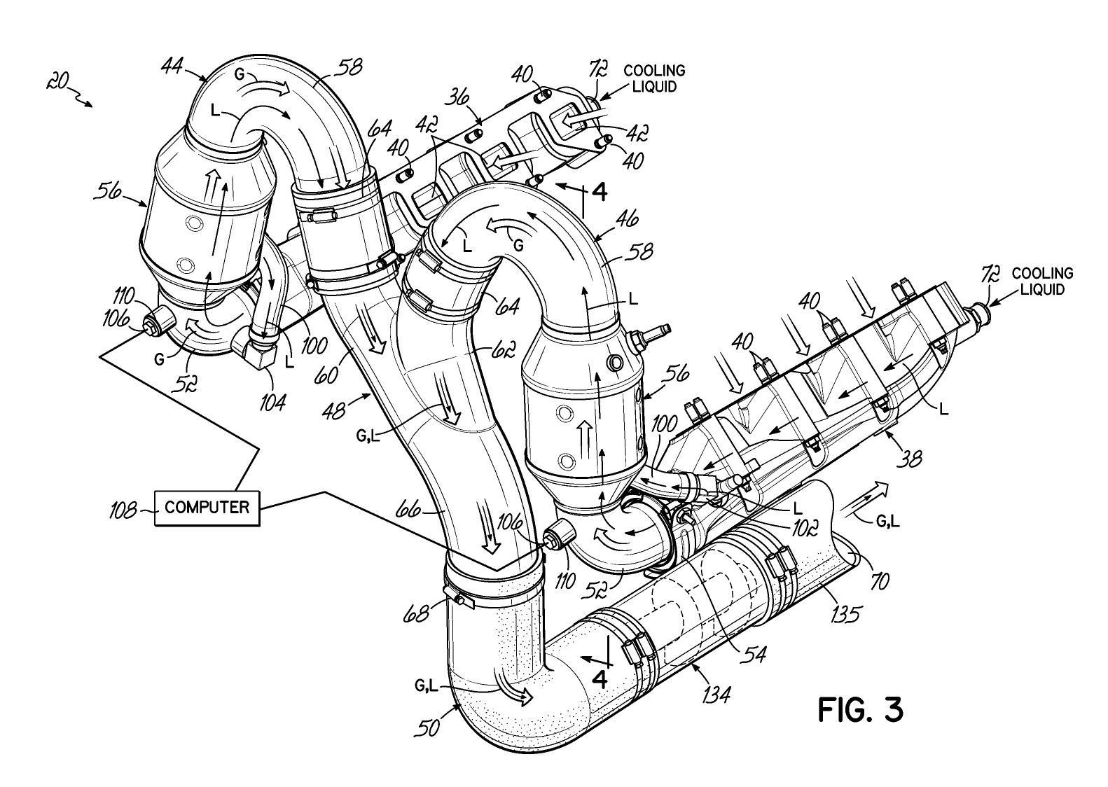

Referring to FIG. 3, the exemplary exhaust system 20 is shown in greater detail, with the engine 22 being hidden from view. The exhaust system 20 generally includes a first exhaust manifold 36 that couples to a first bank of cylinders (not shown) of the engine 22 and a second exhaust manifold 38 that couples to a second bank of cylinders (not shown) of the engine 22 via threaded bolts 40. The engine 22 of FIG. 2 is shown in the form of a “V-8” engine, having two banks of four cylinders arranged in a known V-configuration. However, the muffler of the present invention may be used in any marine engine having any number of cylinders.

Each of the illustrated exhaust manifolds 36, 38 includes four exhaust inlet ports 42, each aligned with and receiving hot exhaust gases G expelled from a respective cylinder of the engine 22. In alternative embodiments, the exhaust manifolds 36, 38, as well as other components of the exemplary exhaust systems disclosed herein, may be modified as desired to accommodate marine engines 22 having various alternative quantities and configurations of cylinders.

The exhaust system 20 further includes first and second riser conduits 44, 46, a Y-pipe 48, and an exhaust outlet conduit 50. Each of the first and second riser conduits 44, 46 includes a lower riser section 52 defining an inlet end portion of the riser conduit 44, 46 coupled to a respective exhaust manifold 36, 38 with a clamp 54; a catalytic converter assembly 56 extending generally vertically from the lower riser section 52; and an upper riser section 58 extending upwardly from the catalytic converter assembly 56 and turning downwardly toward the Y-pipe 48 and defining an outlet end portion of the riser conduit 44, 46.

The Y-pipe 48 includes first and second inlet legs 60, 62 coupled to the first and second riser conduits 44, 46, respectively, with clamped hoses 64, and an outlet leg 66 coupled to the exhaust outlet conduit 50 with a clamp 68. More specifically, the first inlet leg 60 couples to the outlet end of the upper riser section 58 of the first riser conduit 44, and the second inlet leg 62 couples to the outlet end of the upper riser section 58 of the second riser conduit 46.

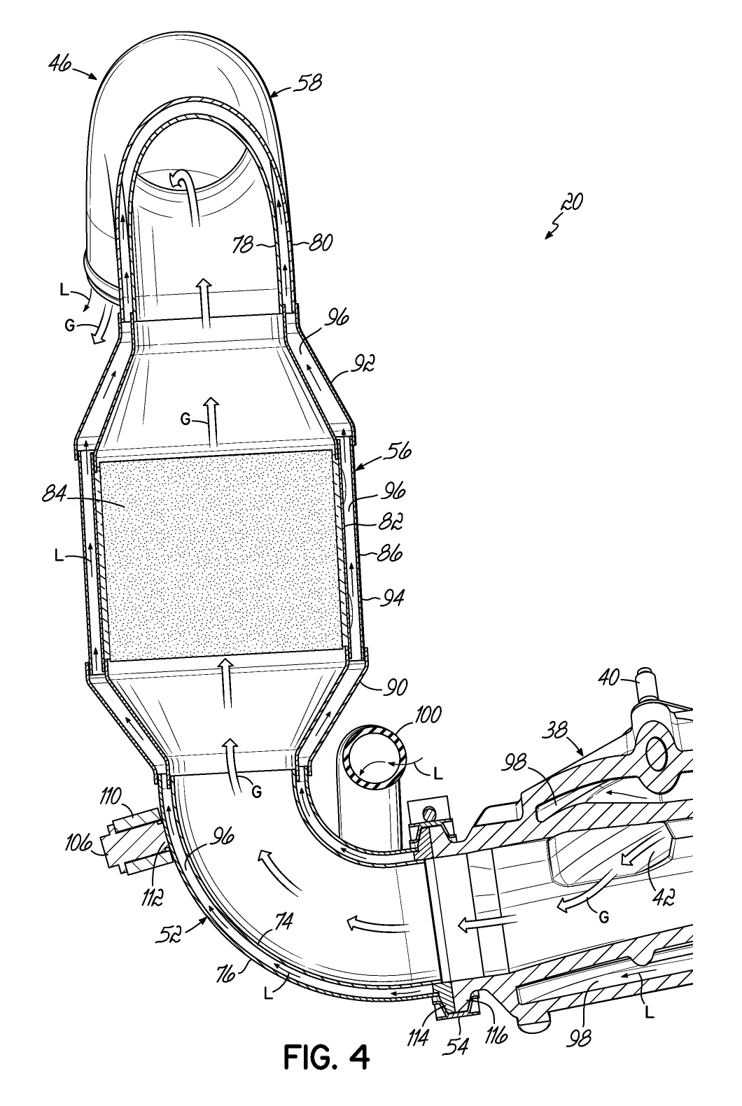

As shown by directional arrows G in FIGS. 3 and 4, exhaust gases G are expelled from the engine 22 into the exhaust manifolds 36, 38. Each exhaust manifold 36, 38 combines the incoming exhaust gases G into a stream, and directs the stream into the lower riser section 52 of the respective riser conduit 44, 46. The exhaust gases G turn upwardly within the lower riser sections 52 and are directed through the catalytic converter assemblies 56, which reduce toxic pollutants in the exhaust gases G. Upon exiting the upper ends of the catalytic converter assemblies 56, the streams of exhaust gases G are directed through the upper riser sections 58 and then into the Y-pipe 48, which combines the two streams of exhaust gases G into a single stream. The unified stream of exhaust gases G is then directed through the outlet leg 66 of the Y-pipe 48 and into the exhaust outlet conduit 50, which directs the exhaust gases G through an exhaust system outlet 70.

The physical configuration of the exhaust outlet conduit 50 as shown in FIG. 3 is merely exemplary. The exhaust outlet conduit 50 may extend for any desired length and with any configuration suitable for directing the exhaust gases G to an external environment. For example, an outlet end of the exhaust outlet conduit 50 may extend externally through a transom or a side of the hull of the motorboat 24, and may include an exhaust tip (not shown) of various types known in the art, for example.

The outer surfaces of the exhaust system 20 are maintained at safe operating temperatures, for example below 200° F., via liquid cooling. More specifically, the exhaust system 20 includes internal cooling passages (referred to collectively as a cooling “jacket”), described below, that circulate cooling liquid L through the components of the exhaust system 20 during operation. In exemplary embodiments, the cooling liquid L may be in the form of water, such as “raw” water drawn from the body of water (e.g., lake or ocean) in which the motorboat 24 is operating. Those skilled in the art will appreciate that the cooling liquid L may take various other forms, such as a synthetic coolant mixture, for example.

Referring to FIG. 4, additional features of the second exhaust manifold 38 and the second riser conduit 46 are shown. While not shown or described in detail, it will be understood that the first exhaust manifold 36 and the first riser conduit 44 are formed with similar structural features.

As shown in FIG. 4, the lower riser section 52 includes an inner conduit 74 and an outer conduit 76 surrounding and spaced radially outward from the inner conduit 74. Likewise, the upper riser section 58 includes an inner conduit 78 and an outer conduit 80 surrounding and spaced radially outward from the inner conduit 78. Similarly, the catalytic converter assembly 56 includes an inner can 82 that houses a catalyst element 84, and an outer can 86 surrounding and spaced radially outward from the inner can 82. The catalytic converter assembly 56 also includes inlet and outlet cone portions 90, 92 that taper from an intermediate portion 94 having an enlarged diameter for accommodating the catalyst element 84. The catalyst element 84 removes toxic pollutants from the exhaust gases G, as described above.

The inner and outer conduits 74, 76 of the lower riser section 52, the inner and outer cans 82, 86 of the catalytic converter assembly 56, and the inner and outer conduits 78, 80 of the upper riser section 58 collectively define a riser cooling passage 96, and may be arranged concentrically. As shown in FIGS. 3 and 4, the riser cooling passages 96 communicate with manifold cooling passage 98 (shown in exhaust manifold 38 in FIG. 4) via a cooling hose 100. Each cooling hose 100 is coupled at an inlet end to a manifold fitting 102 arranged on an outlet end portion of the respective exhaust manifold 36, 38 (see, e.g., exhaust manifold 38 in FIG. 3) and coupled at an outlet end to a riser fitting 104 arranged on an inlet end portion on the lower riser section 52 of the respective riser conduit 44, 46 (see, e.g., riser conduit 44 in FIG. 3).

As shown by directional arrows L in FIGS. 3 and 4, cooling liquid L is directed into the cooling inlets 72 from an external source (not shown) and flows through the manifold cooling passages 98 in a direction parallel to a flow of the exhaust gases G, without contacting the exhaust gases G. The cooling liquid L then flows through the cooling hoses 100 and into the riser cooling passages 96 of the riser conduits 44, 46. In each riser cooling passage 96, the cooling liquid L flows through the lower riser section 52, upwardly through the catalytic converter assembly 56, and into the upper riser section 58. While in the riser cooling passage 96, the cooling liquid L flows parallel to the exhaust gases G but is separated from the exhaust gases G by the inner conduits 74, 78 and the inner can 82. The cooling liquid L then enters into the Y-pipe 48 where it is combined with the exhaust gases G, as indicated by overlapping arrows G, L in FIG. 3. The combined flows of exhaust gases G and cooling liquid L pass downwardly through the outlet leg 66 of the Y-pipe 48 and into the outlet conduit 50, to be passed through a muffler 134 and subsequently ejected together through an additional conduit 135. The outlet conduit 50 and additional conduit 135 may be made of rubber, metal or any desired material. This application is not intended to restrict in any manner these conduits on the upstream and downstream sides of the muffler of the present invention.

As shown in FIG. 4, the lower riser section 52 curves upwardly from an inlet end portion that is oriented generally horizontally, toward an outlet end portion that is oriented generally vertically. The catalytic converter assembly 56 then extends from the outlet end of the lower riser section 52 in a generally vertical orientation. For example, in exemplary embodiments the catalytic converter assembly 56 may extend along an axis that is approximately 15 degrees or less from perfect vertical. In this regard, the catalytic converter assembly 56 may be angled toward the respective exhaust manifold 36, 38, for example. This generally vertical orientation of the catalytic converter assembly 56 facilitates draining of cooling liquid L from the riser cooling passages 96, through drainage ports (not shown) provided on the exhaust manifolds 36, 38, when the engine 22 is turned off. Residual cooling liquid L in the riser cooling passages 96 drains downwardly, in a direction opposite of the arrows L shown in FIGS. 3 and 4.

With continued reference to FIGS. 3 and 4, the exhaust system 20 may further include a pair of skin temperature sensors 106 that communicate with an onboard computer 108 for monitoring surface temperatures of the riser conduits 44, 46. Each riser conduit 44, 46 may include a boss 110 that supports the respective temperature sensor 106 in contacting relation with an outer surface of the riser conduit 44, 46. As shown, each boss 110 may be arranged on the outer conduit 76 of the lower riser section 52 of the respective riser conduit 44, 46. More specifically, the boss 110 may be arranged on a bow-facing side of the lower riser section 52 at a location adjacent to the outlet end of the lower riser section 52, which extends generally vertically with the catalytic converter assembly 56. In one embodiment, the boss 110 may be arranged approximately two inches or less from the inlet cone portion 90 of the catalytic converter assembly 56. Each boss 110 may be formed with a threaded bore that threadedly engages a distal end 112 of the temperature sensor 106 so that the distal end 112 is held in contact with the outer surface of the outer conduit 76 of the lower riser section 52.

Those skilled in the art will appreciate that the lower riser section 52 is generally hotter than downstream components of the riser conduit 44, 46, such as the upper riser section 58, due to being located in closer proximity to the exhaust manifold 36, 38. Accordingly, a surface temperature reading taken at a location along the lower riser section 52 is generally representative of one of the hottest surface temperatures exhibited by the riser conduit 44, 46 during operation of the engine 22. Nevertheless, in alternative embodiments the bosses 110 and temperature sensors 106 may be mounted to the riser conduits 44, 46 at various other locations along the length of the riser conduits 44, 46, including at downstream locations such as the on the upper riser sections 58, for example. Additionally, various alternative quantities of temperature sensors 106 may be used as desired.

Each temperature sensor 106 detects a surface temperature of its respective riser conduit 44, 46, and sends a signal to the computer 108 containing information regarding the detected temperature. Communication between the temperature sensors 106 and the computer 108 may be performed via wires directly connecting the temperature sensors 106 to the computer 108, or alternatively via a wireless network, for example. In response to receiving the signals from the temperature sensors 106, the computer 108 determines whether each riser conduit 44, 46 is receiving an adequate flow of cooling liquid L through its riser cooling passage 96. More specifically, the computer 108 may compare each of the detected temperatures to one or more pre-determined threshold temperatures, and then take additional pre-determined action as appropriate.

In an exemplary embodiment, the computer 108 may determine whether each of the detected temperatures is less than or equal to a base threshold temperature of approximately 160° F. If the detected temperatures satisfy this condition, the computer 108 may conclude that the riser conduits 44, 46 are receiving an adequate flow of cooling liquid L. If the detected temperatures do not satisfy this condition, the computer 108 may take further action. More specifically, if one or both of the detected temperatures is between the base threshold temperature and an elevated threshold temperature, such as 190° F. for example, the computer 108 may log a warning condition and provide a warning message to the user, for example by illuminating one or more indicator lights (not shown) or by displaying a message on a digital display (not shown). If one or both of the detected temperatures is greater than the elevated threshold temperature, the computer 108 may instruct an engine control module (not shown) to decrease rpm's of the engine 22 by a predetermined amount, or according to a programmed algorithm, for example. In this manner, the outer surface temperatures of the exhaust system 20 may be maintained within desirable ranges.

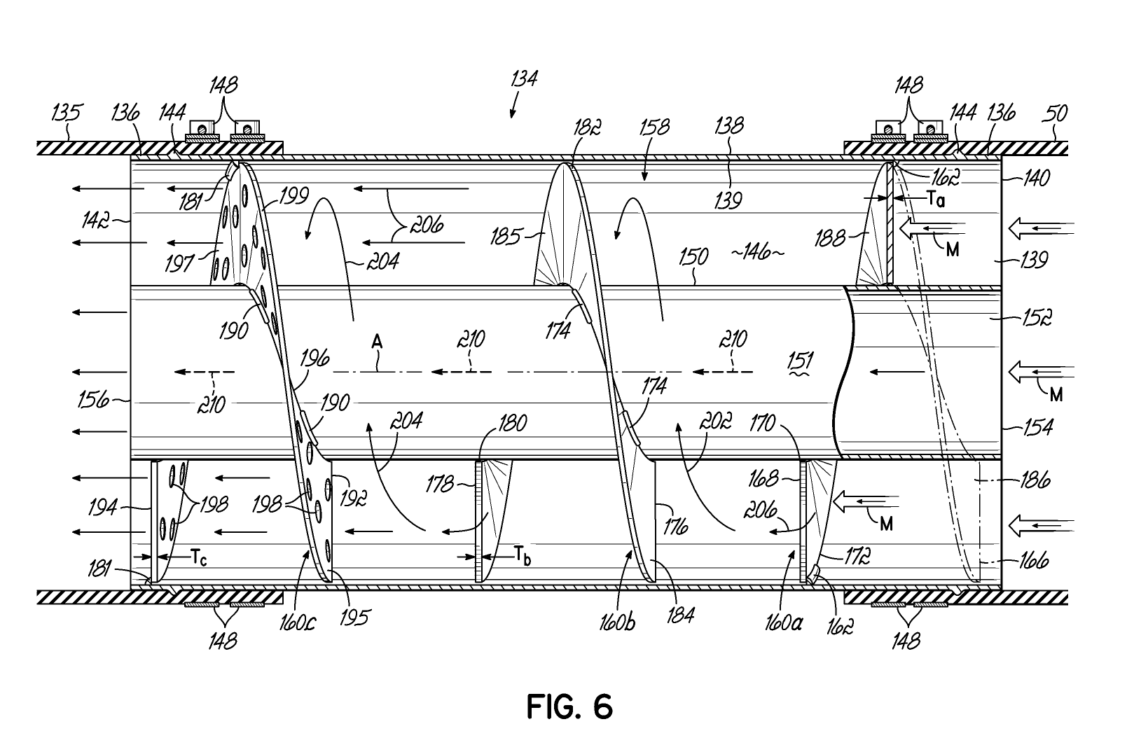

As shown best in FIGS. 3 and 6, the exhaust system 20 further comprises a muffler 134 located between exhaust outlet conduit 50 and additional conduit 135. The additional conduit 135 may be any desired length. The muffler 134 is located downstream of the exhaust outlet conduit 50 and upstream of the additional conduit 135. As best shown in FIG. 6, the exhaust outlet conduit 50 and additional conduit 135 surround outer end portions 136 of an outer conduit 138 of muffler 134.

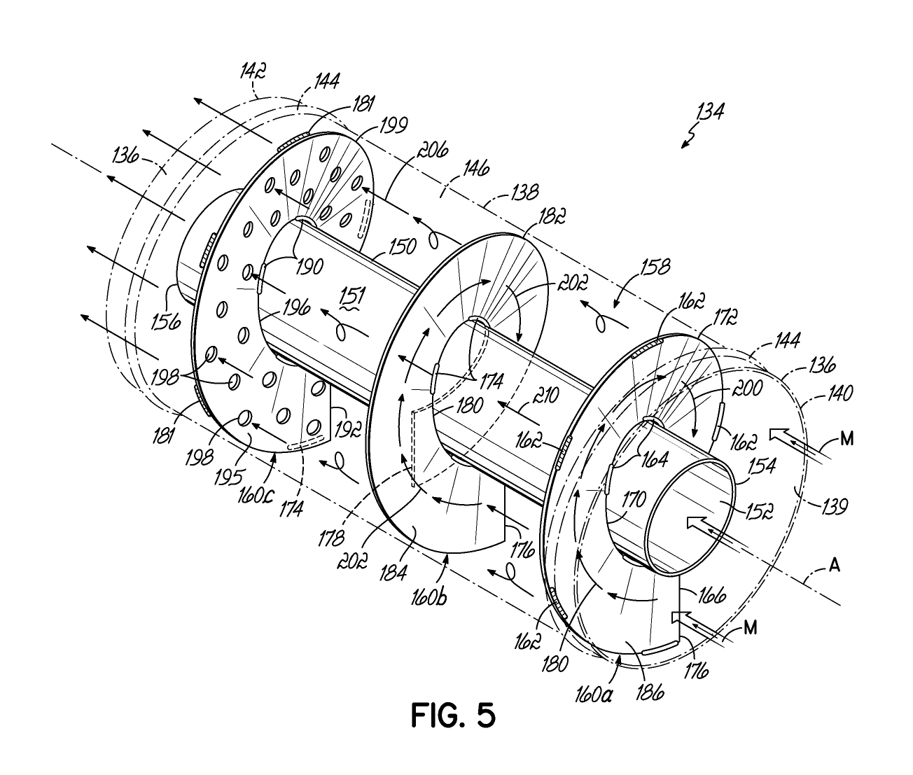

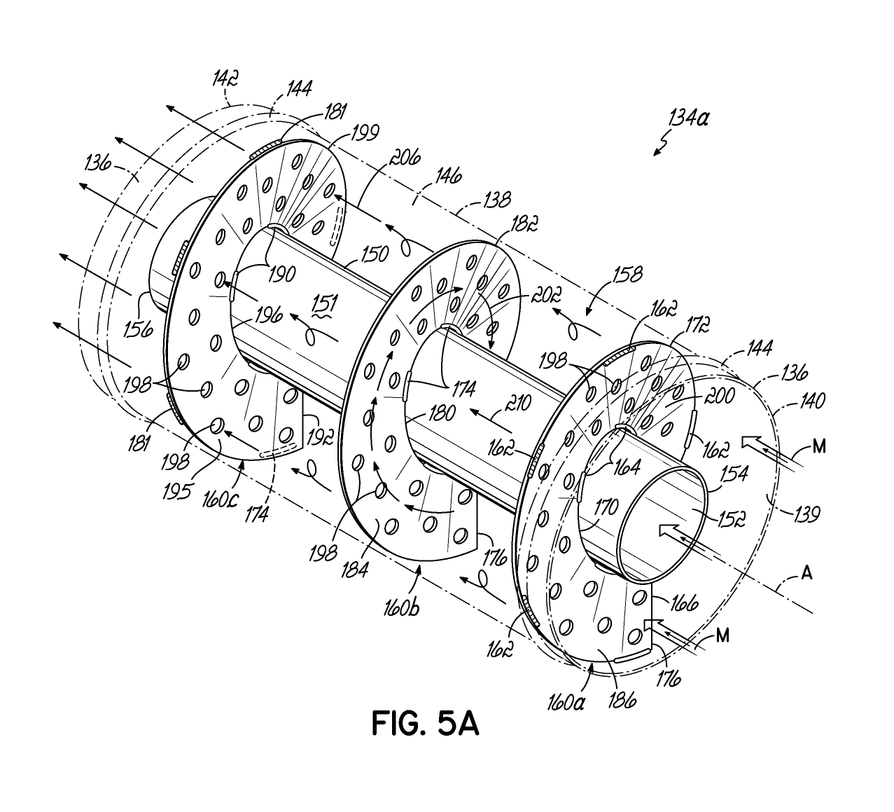

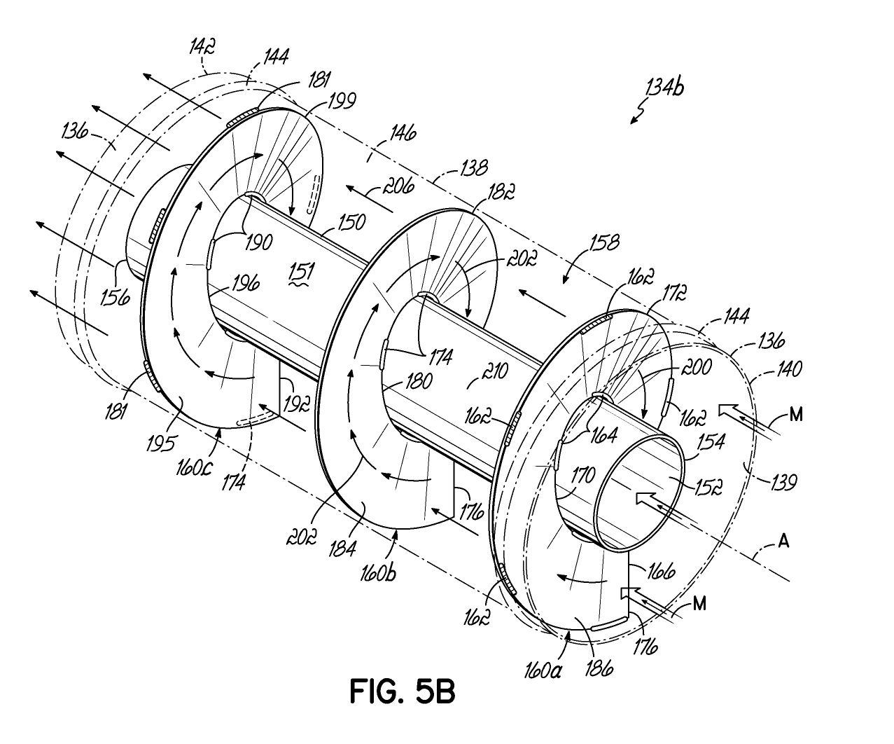

As best shown in FIGS. 5 and 6, the outer conduit 138 of muffler 134 is circular in cross-section and has a longitudinal extending axis A and a hollow interior 139. The outer conduit 138 of muffler 134 has an upstream edge 140 and a downstream edge 142. At each end of the muffler 134, an annular ring 144 extends outwardly from an outer surface 146 of the outer conduit 138 and is inwardly spaced from the upstream and downstream edges 140, 142 of the outer conduit 138. At each end of the muffler 134, the distance between the annular ring 144 and the outer edge 140, 142 of the outer conduit 138 defines one of the outer end portions 136 of the outer conduit 138 of muffler 134.

As best shown in FIGS. 3 and 6, two clamps 148 located inside the annular ring 144 of the outer conduit 138 of muffler 134 secure the exhaust outlet conduit 50 to the muffler 134. The annular rings 144 of the outer conduit 138 of muffler 134 limit movement of the clamps 148 and prevent lateral movement of clamps 148. The clamps 148 and annular rings 144 of the outer conduit 138 of muffler 134 help prevent the exhaust outlet conduit 50 from separating from the upstream outer end portion 136 of the outer conduit 138 of muffler 134. Two additional clamps 148 located inside the annular ring 144 of the outer conduit 138 of muffler 134 secure the additional conduit 135 to the muffler 134. This second or downstream annular ring 144 of the outer conduit 138 of muffler 134 limits movement of the downstream clamps 148 and prevents them from moving over the downstream outer end portion 136 of the outer conduit 138 of muffler 134.

At the upstream end of the muffler 134, the two clamps 148 surround the exhaust outlet conduit 50. Upon being tightened, the clamps 148 secure the exhaust outlet conduit 50 to the outer conduit 138 of muffler 134. Similarly, at the downstream end of the muffler 134, the two clamps 148 surround the additional conduit 135. Upon being tightened, the clamps 148 secure the additional conduit 135 to the outer conduit 138 of muffler 134. Instead of two clamps at each end, any number of clamps, including a single clamp, may be used at either end of any of the mufflers shown or described herein.

As shown best in FIGS. 5 and 6, muffler 134 further comprises an inner conduit 150 having a hollow interior 152 and the same longitudinally extending axis A as concentric outer conduit 138. Inner conduit 150 has the same length as the outer conduit 138, the length being defined as the linear distance between an upstream edge 154 and a downstream edge 156 of inner conduit 150. A cooling passage 158 is defined between the inner and outer conduits 150, 138. The cooling passage 158 extends the entire length of the muffler 134. In operation, the mixture M of exhaust gases G and cooling liquid L extends straight through the hollow interior 152 of inner conduit 150 as shown by arrows 210.

As shown best in FIGS. 5 and 6, muffler 134 further comprises helically-shaped baffles 160a, 160b and 160c in cooling passage 158 of the muffler 134. Each helically-shaped baffle 160a, 160b and 160c is secured to at least one of the inner and outer conduits 150, 138, respectively.

Although muffler 134 shows three helically-shaped baffles 160a, 160b and 160c, any number of helically-shaped baffles may be incorporated into any of the mufflers shown or described herein. Although the drawings show three helically-shaped baffles twisted or swirled in a clockwise direction as the baffle extends downstream (from left to right in FIG. 6), one or more of the helically-shaped baffles may be twisted or swirled in the opposite direction, i.e. a counter-clockwise direction as the baffle extends downstream. Thus, the baffles may be twisted different directions in the cooling passage of any of the mufflers shown or described herein. In any of the embodiments of muffler shown or described herein, all the baffles may be twisted a counter-clockwise direction as the baffle extends downstream in the cooling passage, which is opposite than shown in the drawings.

Upstream helically-shaped or spiral baffle 160a is welded to the outer conduit 138 with spaced weld seams 162 and welded to the inner conduit 150 with spaced weld seams 164. Weld seams 162, 164 are on the upstream side of the helically-shaped baffle 160a. Upstream helically-shaped baffle 160a has a leading or upstream edge 166, a trailing or downstream edge 168, an inner edge 170 abutting the outside surface 151 of inner conduit 150 and an outer edge 172 abutting an inside surface 139 of outer conduit 138. Baffle 160a is shown having a uniform thickness “Ta” between an upstream surface 186 and a downstream surface 188 of baffle 160a. However, in some applications the thickness of the any one of the baffles may vary and not be uniform as shown in the drawings.

Middle helically-shaped or spiral baffle 160b is welded only to the inner conduit 150 with spaced weld seams 174. Weld seams 174 may be on the upstream or downstream side of the helically-shaped baffle 160b. Middle helically-shaped baffle 160b has a leading or upstream edge 176, a trailing or downstream edge 178, an inner edge 180 abutting the outside surface 151 of inner conduit 150 and an outer edge 182 abutting an inside surface 139 of outer conduit 138. Baffle 160b is shown having a uniform thickness “Tb” between an upstream surface 184 and a downstream surface 185. However, in some applications the thickness of the any one of the baffles may vary and not be uniform as shown in the drawings.

Downstream helically-shaped or spiral baffle 160c is welded to the outer conduit 138 with spaced weld seams 181 and welded to the inner conduit 150 with spaced weld seams 190. Weld seams 188, 190 are on the downstream side of the helically-shaped baffle 160c. Downstream helically-shaped baffle 160c has a leading or upstream edge 192, a trailing or downstream edge 194, an inner edge 196 abutting the outside surface 151 of inner conduit 150 and an outer edge 199 abutting an inside surface 139 of outer conduit 138. Baffle 160c is shown having a uniform thickness “Tc” between an upstream surface 195 and a downstream surface 197. However, in some applications the thickness of the any one of the baffles may vary and not be uniform as shown in the drawings.

Although the drawings show each of the three helically-shaped baffles 160a, 160b and 160c filling up the cooling passage 158, one or more the baffles may not extend fully between the inner and outer conduits 150, 138. Although the drawings show each of the three helically-shaped baffles 160a, 160b and 160c being secured to at least one of the inner and outer conduits 150, 138 with a series of weld seams, one or more continuous weld or welds may be used. The drawings are not intended to limit the length or number of weld seams.

Downstream helically-shaped baffle 160c is shown in FIGS. 5 and 6 having a plurality of openings 198 extending through the baffle. Although the openings 198 are shown as being circular they may be any desired shape. Although a certain number of openings 198 are shown extending through baffle 160c, any number of openings may extend through baffle 160c or any of the baffles shown or described herein.

As illustrated by the embodiments shown in FIGS. 5A and 5B, any of the helically-shaped baffles may have any number of openings of any desired shape to facilitate mixing of cooling liquid L and exhaust gases G.

FIG. 5A illustrates a muffler 134a identical to muffler 134 described herein but having openings 198 extending through each of the three helically-shaped baffles 160a, 160b and 160c. For simplicity, like numbers indicate like parts.

FIG. 5B illustrates a muffler 134b identical to muffler 134 described herein but having no openings in any of the three helically-shaped baffles 160a, 160b and 160c. For simplicity, like numbers indicate like parts.

In operation, a mixture M of exhaust gases G and cooling liquid L pass through the hollow interior 152 of the inner conduit 150 and through the cooling passage 158 between the inner and outer conduits 150, 138. In the drawings the mixture is shown by overlapping arrows. In the cooling passage 158 the mixture M contacts the upstream surface 186 of the upstream helically-shaped baffle 160a and moves along such surface in the direction of arrows 200 as shown in FIGS. 5 and 6. Similarly, in the cooling passage 158 the mixture M contacts the upstream surface 190 of the middle helically-shaped baffle 160b and moves along such surface in the direction of arrows 202 as shown in FIGS. 5 and 6. Similarly, in the cooling passage 158 the mixture M contacts the upstream surface 194 of the downstream helically-shaped baffle 160c and moves along such surface in the direction of arrows 204 as shown in FIGS. 5 and 6. The helically-shaped baffles 160a, 160b, 160c thus facilitate mixing and/or movement of the exhaust gases G and cooling liquid L in the cooling passage 158. Such mixing, movement helps lower the skin temperature of the muffler and particular the upper portion of the muffler.

Due to the openings 198 in the downstream helically-shaped baffle 160c a portion of the mixture extends through the openings 198 as shown by arrows 206 in FIGS. 5 and 6.

An advantage of the resultant additional mixing due to the presence of the helically-shaped baffles 160a, 160b and 160c in the cooling passage 158 is that the engine back pressure is reduced thereby increasing engine performance. Another advantage is the muffler is more adequately flushed with the cooling liquid L, thereby substantially decreasing the risk of entrapping precipitated salts and other particulate from the cooling liquid L, particularly when the cooling liquid includes “raw” water. Advantageously, reducing entrapment and collection of such salts and precipitates reduces corrosive effects that they might otherwise have on the muffler, thereby extending the useful life of the muffler.

Although the mufflers shown and described herein are illustrated being part of an exhaust system as shown in U.S. patent application Ser. No. 15/194,002, which is fully incorporated herein, the mufflers shown and described herein may be used in any marine exhaust system.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

1. An exhaust muffler for a marine engine exhaust system, comprising:
an inner conduit;
an outer conduit surrounding the inner conduit so as to define a cooling passage between the inner and outer conduits, the outer conduit having an inlet end portion for connection to a first exhaust conduit and an outlet end portion for connection to a second exhaust conduit that directs exhaust gases and liquid toward an exhaust system outlet; and
multiple helically-shaped baffles spaced from each other in the cooling passage to facilitate mixing of liquid and exhaust gas inside the cooling passage, each of the helically-shaped baffles having only one revolution.

2. The exhaust muffler of claim 1, wherein the inner and outer conduits are tubes.

3. The exhaust muffler of claim 1, wherein at least one of the baffles has openings therethrough to facilitate mixing of liquid and exhaust gas inside the cooling passage.

4. The exhaust muffler of claim 1, wherein each of the baffles is welded to at least one of the inner and outer conduits.

5. The exhaust muffler of claim 1, wherein at least one of the baffles is welded to the inner and outer conduit.

6. The exhaust muffler of claim 1, wherein at least one of the inner and outer conduits has a uniform diameter.

7. An exhaust muffler for a marine engine exhaust system, comprising:
an inner conduit having a smooth interior through which liquid and gas pass;
an outer conduit surrounding the inner conduit so as to define a cooling passage between the inner and outer conduits for transporting a mixture of exhaust gases and cooling liquid, the inner and outer conduits having inlet and outlet edges and being the same length;
multiple, spaced helically-shaped baffles in the cooling liquid passage to facilitate mixing of liquid and exhaust gas inside the cooling passage; and
the outer conduit having annular rings spaced inwardly from inlet and outlet edges of the outer conduit to help retain exhaust conduits and clamps.

8. The exhaust muffler of claim 7, wherein at least one of the baffles has openings therethrough.

9. The exhaust muffler of claim 7, wherein each of the baffles is welded to at least one of the inner and outer conduits.

10. The exhaust muffler of claim 7, wherein at least one of the baffles is welded to the inner and outer conduits.

11. The exhaust muffler of claim 7, wherein each of the baffles extends between the inner and outer conduits.

12. The exhaust muffler of claim 7, wherein the inner and outer conduits have the same length.

13. An exhaust muffler for a marine engine exhaust system, comprising:
an inner conduit;
an outer conduit surrounding the inner conduit to define a cooling passage between the inner and outer conduits for transporting a mixture of exhaust gases and cooling liquid;
a middle spiral baffle and outer spiral baffles on opposite ends of the middle spiral baffle in the cooling liquid passage to facilitate mixing of liquid and exhaust gas inside the cooling passage wherein a mixture of liquid and exhaust gas flows through the inner conduit and some of the mixture flows through the cooling passage.

14. The exhaust muffler of claim 13, wherein the outer conduit has inlet and outlet edges, the outer conduit having annular rings spaced inwardly from the inlet and outlet edges of the outer conduit to allow clamps to secure flexible hoses over the outer conduit.

15. The exhaust muffler of claim 13, wherein the inner conduit has a smooth interior.

16. The exhaust muffler of claim 13, wherein at least one of the spiral baffles has openings therethrough to increase mixing of liquid and exhaust gas inside the cooling passage.

17. The exhaust muffler of claim 13, wherein each of the baffles is welded to at least one of the inner and outer conduits.

18. The exhaust muffler of claim 13, wherein each of the spiral baffles has openings therethrough to facilitate mixing of liquid and exhaust gas inside the cooling passage.

19. The exhaust muffler of claim 13, wherein at least one of the baffles is welded to the inner and outer conduits.

20. The exhaust muffler of claim 13, wherein each of the baffles has multiple openings extending through the baffle.
